(19) United States
(12) Patent Application Publication
(10) Pub. No.: US 2011/0186627 A1
(43) Pub. Date: Aug. 4, 2011

(54) Combination ATM/Vending Machine Kiosk

(76) Inventor: David Kreamer, Shreveport, LA (US)

(21) Appl. No.: 13/010,704

(22) Filed: Jan. 20, 2011

Related U.S. Application Data
(63) Continuation of application No. 12/262,135, filed on Oct. 30, 2008, now abandoned.
(60) Provisional application No. 61/000,850, filed on Oct. 30, 2007.

(51) Int. Cl. G07F 19/00

(52) U.S. Cl. 235/379

(57) ABSTRACT

An all-purpose ATM kiosk/vending machine network that services the unbanked and underbanked markets, that will enables wireless transactions and processing of currency, pre-paid cash debit cards, and online banking. The concept can be applied to any vending machine product such as sodas, beverages, gasoline, candy, postage stamps, and more with the following features and benefits: Full service ATM/Vending, Issue cash debit cards, Transfer funds from one machine to another Issues and prints money orders, Bill paying GPS travel directions, Advertising on LCD screen, Purchase sporting/event tickets Reload cell phone pre-paid cards, Purchase beverage or gas, Wireless Internet access, and Bank-to-bank wire transfers. The present invention will provide financial services solutions to sub-prime prospects and the unbanked. The present invention will also provide online/wireless banking, prepaid cards, and secured lending products to customers who may not qualify for conventional bank unsecured lending products, or whose needs cannot be met by traditional lenders.

### CROSS REFERENCE TO RELATED APPLICATIONS

This application is a continuation of U.S. patent application Ser. No. 12/262,135, entitled “Combination ATM/Vending Machine Kiosk”, filed on 30 Oct. 2008. The benefit under 35 USC §119(e) of the United States provisional application is hereby claimed, and the aforementioned application is hereby incorporated herein by reference.

This application claims priority from U.S. Provisional Patent Application Ser. No. 61/000,850, entitled “Combination ATM/Vending Machine Kiosk”, filed on 30 Oct. 2007. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to automated service kiosks. More specifically, the present invention relates to an all-purpose cyber bank that services the unbanked and underbanked markets, through the use of an ATM kiosk/vending machine network that will enable wireless transactions and processing of currency, pre-paid cash debit cards, and online banking.

### BACKGROUND OF THE INVENTION

The last two decades have been marked by significant changes in consumer financial services. Two significant changes that have been evident are the rapid growth of both subprime mortgage lending and alternative financial service providers (AFSPs), such as check cashers, payday lenders, and pawnshops. A common concern with both of these industries is high fees for their services and disproportionate targeting of low-income and minority households. Another common element regarding these trends is the variety of studies arguing that the growth in use of these higher-cost financial services in low-income and minority communities is due in part to the absence of banks from these areas.

In the United States in 2005, 68 percent of the country's nearly 400,000 ATMs were in retail or off premises locations, according to the American Bankers Association. And some industry insiders expect that number to increase as new sites for ATMs crop up over the next five years. With 10.5 billion ATM transactions conducted in the United States in 2005, according to ABA, opportunity exists for retailers, ISOs and FIs to have pieces of the ATM-revenue pie.

In today's financial market, retailers that do not provide a cash-access point for their customers are working at a disadvantage. Since private ATM machines gained legal status in 1995, their numbers, their market share and their profits have been growing rapidly. It is a known fact that ATM users pay much more attention to the convenience of the machines than the cost of using them. Owning one or more ATM's can be a very profitable business for the owner of the machines retains most of the transaction fees!

Privately-owned ATM's process billions of dollars worth of business in cash transactions yearly and collect tens of millions of dollars in fees for doing so. Interchange can play a critical role in an ATM deployment because it's often used to help ISOs cover fees associated with regulatory compliance. For the retailer, building in additional profit-making opportunities is the name of the game. To that end, many are leaning on advanced self-service functions.

The number of transactions occurring at ATMs has been sporadic over the past 10 years. According to ABA, there were 10.5 billion U.S.-based transactions in 2005, a 5 percent decrease from the 11 billion ATM transactions conducted in 2004, and a 30 percent decrease from the 13.6 billion transactions conducted in 2001. One way retailers have sought to combat the decline is through the implementation of advanced-function ATMs. Not all retailers have adopted the notion of check cashing, bill-payment and automated-deposit functionalities on ATMs; however, industry experts say additional revenue-generating possibilities are promising, especially with an estimated U.S population of more than 44 million unbanked and underbanked consumers. Advanced-function ATMs opens up the opportunity to generate increased revenue and profit in the same small footprint that currently supports ATM transactions only. NCR EasyPoint developed the 3800 ATM. A sidecar can be attached to the 3800 that enables bill-pay, pre-paid card dispensing and other advanced functionalities.

Most Americans conduct their financial affairs using retail banks or similar mainstream financial institutions, giving them ready access to some of the most efficient and sophisticated financial services in the world. But alongside these consumers, millions of minority and low-income households conduct financial transactions without ever using mainstream financial services. Indeed, according to a recent estimate, as many as 56 million adults have no relationship to mainstream financial service providers. Many of these consumers often rely on alternative financial service providers—check-cashing outlets, payday lenders, pawnshops, rent-to-own stores, and auto title lenders. While these alternative, non-bank financial service providers offer convenient services and easy access to cash, their services often carry high costs, limiting low-income families' ability to accumulate assets and establish a credit history.

### SUMMARY OF THE INVENTION

The present invention will provide financial services solutions to sub-prime prospects and the unbanked. The present invention will also provide online/wireless banking, prepaid cards, and secured lending products to customers who may not qualify for conventional bank unsecured lending products, or whose needs cannot be met by traditional lenders.

It is a continued objective to create an all-purpose cyber bank that services the unbanked and underbanked markets, through the use of an ATM kiosk/vending machine network that will enable wireless transactions and processing of currency, pre-paid cash debit cards, and online banking. The concept can be applied to any vending machine product such as sodas, beverages, gasoline, candy, postage stamps, and more with the following features and benefits: Full service ATM/Vending, Issue cash debit cards, Transfer funds from one machine to another Issues and prints money orders, Bill paying GPS travel directions, Advertising on LCD screen, Purchase sporting/event tickets Reload cell phone pre-paid cards, Purchase beverage or gas, Wireless Internet access, and Bank-to-bank wire transfers.

The present invention will also include a display that can be accessed to prompt the banking machine functions and display advertisements. The connectivity of the present invention to an Internet cyber-bank provides the wireless connectivity that will mirror PayPal with banking abilities as well as in the online processing of: Rechargeable cash debit cards, Virtual payments via email, Package deal for mortgage/auto/insurance purchase, Best rate for mortgage/auto loans for all customers (e.g. flat rate 6%), College ID/cash debit cards, Payroll cards with residuals paid back to card affiliate. Once the user is connected to the Internet highway through the cyber bank, he/she will be connected automatically to the ACH network and the internet bank site. This will enable the user to have unlimited possibilities for plug-ins and add-ons such as travel directions, maps, online searches through any search engine, etc.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1. depicts a frontal view of a combination ATM and soft drink vending machine; and

FIG. 2 depicts a frontal view of a combination ATM and gasoline vending system.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. Now referring to Figures, the embodiment of the combination ATM/Vending machine kiosk is illustrated.

The present invention is a storefront kiosk that combines an ATM with any type of vending machine, including vending machines that sell soft drinks, candies, snacks, etc. or products such as gasoline. With this invention, product revenue can be combined with banking revenue by combining all of the advanced features of an ATM machine with a product Vending machine.

Not only would the user be able to complete a bank transaction, the user could also purchase anything from beverages and candy to cell phone accessories to gasoline all in one transaction. After an ATM transaction, the screen will automatically ask the consumer if they would like to purchase a drink, snack, etc. These combination ATM/Vending Machine Kiosks could be placed in strategic locations such as shopping malls, hotels, convenience stores, sporting venues, municipal buildings, such as but not limited to, centers for motor vehicle registrations and licensing issues, etc. The gasoline ATM/Vending combination would be designed to comply with all local, state, and federal regulations relating to gasoline sales.

Not only would this ATM/vending machine benefit consumers by its convenience, it would also benefit the vendor with revenue from ATM transaction fees in addition to the profit received off of the item purchased. A vendor could either buy the machine or lease it from the vending manufacturer. This combination ATM/vending machine could then be placed in strategic locations and pay a percentage or residual of the profits to the business owner where the machine sits. Also, any beverage, snack, etc. corporation could purchase these combination machines themselves and place them in the strategic location of their choice.

Yet another way this innovative ATM/vending machine benefits the owner is through advertising, which would be done through a scrolling or standstill message on the screen. Advertisers would then pay a fee to the machine owner. Businesses wishing to advertise might be product manufacturers of the vending machine items, banks, local small business owners, or large corporations.

Another function of the machine would be the ability to produce an instant cash debit card. For example, the consumer could deposit money into the ATM and instantly receive a cash debit card in equal to the amount of money deposited. Standardized Computer check print out and cash disbursement would be possible, whereby a person goes online and sets up an account, transfers money to a computerize check which then can be cashed at any ATM/Vending Machine. The ATM machine only recognizes these checks that are printed online. A second-generation combination ATM/Vending machines could be used to transfer money from one machine to another, similar to a Western Union service.

The prior art does not teach nor suggest the creation of a multi-functional combination ATM/vending machine. This concept takes vending and ATM use to the next level, increasing the progression to a cashless society. Conveniences the Combination ATM/Vending system provides to a vendor include Triple revenue producer—Products, Transaction Fees, Advertising, Exclusive Rights Possibility for Coke or Pepsi, Cash debit card Distributor, Cash Transfers from one machine to another, Bill Paying, Cash Dispenser, and Check Cashing.

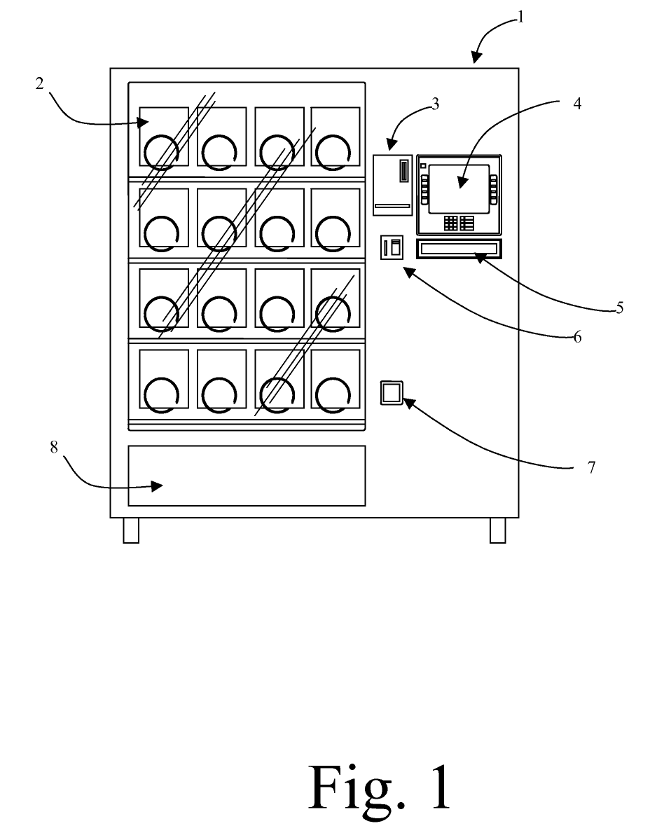

Now referring to FIG. 1, a frontal view 1 of a combination ATM and soft drink vending machine is illustrated. In one embodiment a combination ATM and soft drink vending machine would consist of a front surface 1, with a plurality of soft drink vending spaces 2, bottle cap opener 7, and soft drink dispenser 8. Additionally the device would include, a credit card slot 3, a first display screen 4, and a second display screen 6 to identify other transactions.

A fully function ATM and vending machine combination would dispense beverages while displaying scrolling advertisements (purchased by businesses and corporations) in between customer use. The ATM and vending machine provides 24-hour access to a Full-function ATM (withdraw cash, check account balance, etc.). In addition, the ATM will have the ability to accept cash, credit/debit card, or access bank accounts in order to: Receive a loaded cash debit card directly from machine, reload funds on cash debit cards, email funds to another email account by accessing a secure cyber-bank site, purchase cash gift card which would be mailed or emailed via cyber bank, transfer funds from one machine to another machine, obtain money orders from the machine, and every card dispensed would have logo imprinted on it.

All fees would be divided among beverage company, bank, and vendor location including the ATM fee, transaction fees, gift card fee, money order fee, money transfer fee (machine to machine), virtual fee, and scrolling advertisement fees.

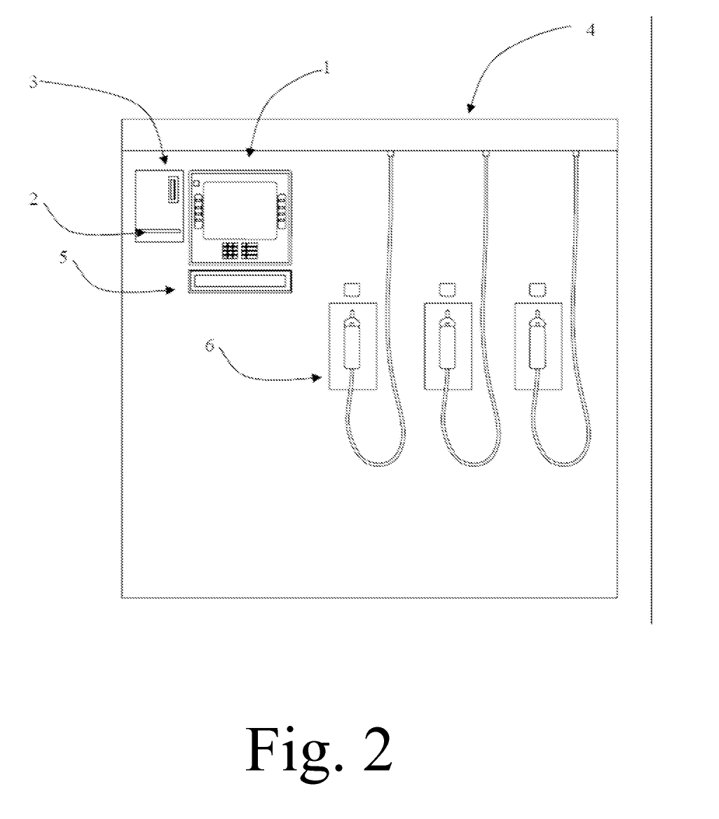

Now referring to FIG. 2, an alternative embodiment of the present invention is shown being depicted as a frontal view of a combination ATM and gasoline vending system 4. The combination ATM and gasoline vending system consists of gasoline selection and dispensing means 6, an ATM monitor 1, credit card slot 3, with an additional slot 2 for delivery of a printed receipt. A screen 5 is provided to enable the user to identify other transactions.

A fully functioning ATM and gas pump combination would dispenses gasoline while displaying scrolling advertisements (purchased by businesses and corporations) in between customer uses. The ATM and gas pump combination provides 24-hour access to a full-function ATM (withdraw cash, check account balance, etc.). In addition, the ATM and gas pump combination will have the ability to accept cash, credit/debit card, or access bank accounts in order to: Receive a loaded cash debit card directly from machine, reload funds on cash debit cards, email funds to another email account by accessing a secure cyber-bank site, purchase cash gift card which would be mailed or emailed via cyber bank, transfer funds from 1 machine to another machine, obtain money orders from the machine, every card dispensed would have the company logo imprinted on it.

All fees from the ATM and gas pump combination would be divided among the gas company, bank, and vendor location including the ATM fee, transaction fees, gift card fee, money order fee, money transfer fee (machine to machine), virtual fee, and scrolling advertisement fees.

A fully functioning Convenience Store ATM that would dispenses items while displaying scrolling advertisements (purchased by businesses and corporations) in between customer use. The ATM and gas pump combination provides 24-hour access to a full-function ATM (withdraw cash, check account balance, etc.). In addition, the ATM and has the ability to accept cash, credit/debit card, or access bank accounts in order to: Receive a loaded cash debit card directly from machine, reload funds on cash debit cards, email funds to another email account by accessing a secure cyber-bank site, purchase cash gift card which would be mailed or emailed via cyber bank, transfer funds from 1 machine to another machine, obtain money orders from the machine, every card dispensed would have the company logo imprinted on it.

All fees from the ATM would be divided among the gas company, bank, and vendor location including the ATM fee, transaction fees, gift card fee, money order fee, money transfer fee (machine to machine), virtual fee, and scrolling advertisement fees.

In an alternative embodiment, a fully functioning lottery ticket machine that would dispense lottery tickets or other items while displaying scrolling advertisements (purchased by businesses and corporations) in between customer use may be developed. The ATM and lottery machine combination provides 24-hour access to a full-function ATM (withdraw cash, check account balance, etc.). In addition, the ATM and has the ability to accept cash, credit/debit card, or access bank accounts in order to: Receive a loaded cash debit card directly from machine, reload funds on cash debit cards, email funds to another email account by accessing a secure cyber-bank site, purchase cash gift card which would be mailed or emailed via cyber bank, transfer funds from 1 machine to another machine, obtain money orders from the machine, every card dispensed would have the company logo imprinted on it.

All fees from the ATM would be divided among the lottery company, bank, and vendor location including the ATM fee, transaction fees, gift card fee, money order fee, money transfer fee (machine to machine), virtual fee, and scrolling advertisement fees.

In yet another alternative embodiment, educational institutions could provide a student ID card with a sponsor or company appearance and school logo. The system and infrastructure of the present invention can be used to load college funds (scholarships, grants, and school loans) onto the card for student use. Parents can load funds onto student's card from an on-line cyber bank, ATM/vending, ATM/gas pump, convenience store ATM, or any other ATM combination machine. Loading can occur directly from any machine on the network or by providing a routing number and bank account from which funds can be transferred to the student. Students can load cash onto card for safekeeping or budgeting purposes and cards can be programmed for secure dorm access. Additionally, a teacher payroll card could be created for disbursing salary or other payments by having them deposited directly onto card. Duplicate cards could also be made available for spouse and children providing access to funds in a limited or unlimited manner as well as access to buildings.

All fees from the ATM would be divided among the sponsoring company, bank, school, and vendor location including the ATM fee, transaction fees, gift card fee, money order fee, money transfer fee (machine to machine), virtual fee, and scrolling advertisement fees.

Corporate America could also implement the present invention by providing employer ID cards with a sponsoring company and company logo. This would provide residual cash payback to the company that issues the company payroll card while providing full access to cyber bank features (discount auto and mortgage loans) to their employees. Payroll software set up in conjunction with a cyber bank for direct deposit convenience could also be incorporated in addition to an ATM/vending machine located in place of employment for easy access.

All fees from the ATM would be divided among the sponsoring company, bank, school, and vendor location including the ATM fee, transaction fees, gift card fee, money order fee, money transfer fee (machine to machine), virtual fee, cash back revenue for every purchase made with employee ID card, and scrolling advertisement fees.

With respect to the Cyber Bank component of the present invention, a user would first open a cyber bank account. This would permit them to: Reload cards; Issue picture ID cash debit cards; issue gift cards; provide Auto and mortgage loans; enable an option to escrow insurance with mortgage and auto loans; provide payroll cards; create affiliate programs; provide life and accident insurance; provide credit life insurance; enable electronic bill paying; enable the purchase of CD's and gift cards; allow for the open of savings and Christmas club accounts Revenue Makers All fees to be divided among Beverage Co, bank, and vendor location. All fees from the ATM would be divided among the sponsoring company, bank, school, and vendor location including the ATM fee, transaction fees, gift card fee, money order fee, money transfer fee (machine to machine), virtual fee, cash back revenue for every purchase made, deposits, scrolling advertisement fees; auto and mortgage loan interest income/; insurance; and affiliate programs.

In alternative embodiment of the present invention additional features could also be included such as, but not limited to; issuing cash debit cards; transfer funds from one machine to another; issuing and printing money orders, Bill paying, GPS travel directions, Advertising on LCD screen, Purchase sporting/event tickets, reload cell phone pre-paid cards, Wireless internet access, Internet Banking Features.

Furthermore, other areas of art may benefit from this method and adjustments to the design are anticipated. Thus, the scope of the invention should be determined by the appended claims and their legal equivalents, rather than by the examples given.

1. A method providing a combination of an ATM and vending machine kiosk with banking services comprising:
a combination ATM and a vending machine with connection to a multi-user network consisting of;
a plurality of vending spaces,
products for vending;
a credit card slot;
one or more display screens;
the ability to accept cash, credit/debit card, or access bank accounts;
providing one or more ATM/vending machine kiosks located at identified locations connected to each other via the multi-user network;
transferring money from one machine to another, between accounts, or from one party to another by:
depositing cash into the machine;
providing the machine with a routing number and account number to send money to a cash debit card; or
depositing cash into the machine to generate the issuance of a check or money order; and
after an ATM transaction, a display screen automatically provides a prompt to initiate a purchase of a product from the ATM/vending machine kiosk;

2. The method of claim 1 wherein, the ATM/vending machine kiosks consist of a storefront kiosk that combines an ATM with any type of vending machine, including vending machines that sell soft drinks, candies, snacks, etc. or products such as gasoline.

3. The method of claim 1 wherein, product revenue is combined with banking revenue by combining all of the advanced features of an ATM machine with a product vending machine.

4. The method of claim 1 wherein, the ATM/vending machine kiosks are placed in shopping malls, hotels, convenience stores, sporting venues, and municipal buildings.

5. The method of claim 1 wherein, the ATM/vending machine kiosks dispense beverages while displaying scrolling advertisements purchased by businesses and corporations in between customer use.

6. The method of claim 1 wherein, the ATM/vending machine kiosks accepts cash, credit/debit card, or access bank accounts in order to:
receive a loaded cash debit card directly from machine;
reload funds on cash debit cards;
email funds to another email account by accessing a secure cyber-bank site;
purchase cash gift cards that are mailed or emailed via cyber bank;
transfer funds from one machine to another machine;
obtain money orders from the machine, and
dispensed a cash debit card.

7. The method of claim 7 wherein, the ATM/vending machine kiosk provide money transfer to a computerize check or cash debit card which is then cashed at any ATM/vending machine.

8. The method of claim 7 wherein, the ATM/vending machine kiosks provide standardized computer check cashing and cash disbursement.

9. The method of claim 1 wherein, the ATM/vending machine kiosks:
pay a vendor with revenue from ATM transaction fees in addition to the profit received off of an item purchased;
pay a percentage or residual of the profits to a business owner where the machine sits;
pays the business owner through advertising delivered through a scrolling or standstill message on the display screen; and
pays the machine owner a fee from Advertisers.

10. The method of claim 1 wherein, the ATM/vending machine kiosks accepts cash, in order to produce an instant cash debit card equal to the amount of money deposited.

11. The method of claim 1 wherein, the ATM/vending machine kiosks accepts cash, credit/debit card, or access bank accounts in order to produce an instant cash debit card.

12. The method of claim 10 wherein, the dispensed cash debit card consists of a paid advertisement.

13. The method of claim 1 wherein, the ATM/vending machine transfers money from one machine to another machine on the multi-user network.

14. The method of claim 1 wherein, the ATM/vending machine consists of a combination ATM and gasoline vending system comprising gasoline selection and dispensing means, an ATM monitor, credit card slot, an additional slot for delivery of a printed receipt and a secondary display screen to enable the execution of other, secondary transactions.

15. The method of claim 1 wherein, the ATM/vending machine:
dispenses gasoline while displaying scrolling advertisements purchased by businesses and corporations;
provides 24-hour access to a full-function ATM; and
accepts cash, credit/debit card, or access bank accounts in order to:
receive a loaded cash debit card directly from machine;
reload funds on cash debit cards;
email funds to another email account by accessing a secure cyber-bank site;
purchase cash gift card which would be mailed or emailed via cyber bank;
transfer funds from one machine to another machine;
obtain money orders from the machine and
dispense cash debit cards that have a company logo or advertisement imprinted on them.

16. The method of claim 1 wherein, the ATM/vending machine:
provides a student ID card with a sponsor or company appearance and school logo;
provides means for loading college funds onto the card for student use;
provides means for other funds to be loaded onto the student's card from an on-line cyber bank, ATM/vending, ATM/gas pump, or convenience store ATMs;
provides means for receiving money from a bank via a routing and account number;
provides means for students to load cash onto card; and
programmed for secure dorm access.

17. The method of claim 1 wherein, the ATM/vending machine:
providing teacher payroll card for disbursing salary or other payments by having them deposited directly onto card;
providing duplicate cards providing access to funds in a limited or unlimited manner; and
programmed for secure dorm access.

18. The method of claim 1 wherein, the ATM/vending machine:
providing employer ID cards with a sponsoring company and company logo;
providing residual cash payback to the company that issues the company payroll card;
providing full access to cyber bank features to employees;
providing payroll software set up in conjunction with a cyber bank for direct deposit;
locating an ATM/vending machine in the place of employment for easy access.

19. The method of claim 18 wherein, the ATM/vending machine wherein a user would:
open a cyber bank account;
Reload cards;
issue picture ID cash debit cards;
issue gift cards;
provide auto and mortgage loans;
enable an option to escrow insurance with mortgage and auto loans;
provide payroll cards;
create affiliate programs;
provide life and accident insurance;
provide credit life insurance;
enable electronic bill paying;
enable the purchase of CD's and gift cards; and
allow for the open of savings and Christmas club accounts.

20. The method of claim 1 wherein, the ATM/vending machine
issues cash debit cards;
transfer funds from one machine to another;
issues and prints money orders,
provides bill paying,
provides GPS travel directions,
provides advertising on display screens,
provides for the purchase of sporting or event tickets,
reloads pre-paid cell phone cards,
provides wireless Internet access, and
provides internet banking features.
